(19) United States
(12) Patent Application Publication
(10) Pub. No.: US 2003/0085193 A1
(43) Pub. Date: May 8, 2003

(54) Feeding bottle assembly

(76) Inventor: Shen-Kwang Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,702

(22) Filed: Nov. 6, 2001

(51) Int. Cl. B65D 23/10; A47J 41/02; B65D 23/00

(52) U.S. Cl. 215/11.1; 215/12.1; 215/396

(57) ABSTRACT

A feeding bottle assembly mainly has an external bottle, an internal bottle and a cap. Either the external bottle or the internal bottle is able to conjugate with the cap to form a single bottle configuration so as to provide different capacities. The internal bottle is able to selectively be placed within the external bottle and the cap simultaneously encloses the external and the internal bottles to assemble as a dual-bottle configuration.

### BACKGROUND OF THE INVENTION

1. Field of Invention

The present invention relates to a feeding bottle assembly, and more particularly to a feeding bottle assembly that mainly has an external body and an internal body to selectively assemble as a dual-bottle configuration to reduce the space that the feeding bottle assembly occupies, wherein either the external body or the internal body is able to be used as a single bottle configuration so as to respectively provide different capacities.

2. Related Art

The conventional feeding bottle is formed as a single tubular body and has a standard capacity, thus the single tubular body only provides a constant capacity. However, in accordance with the growing of the infant, the feeding quantity for the infant is also increased, and parents usually must prepare multiple feeding bottles with different capacity to meet the infant's situation. Such multiple feeding bottles usually occupy too much space and are inconvenient to store. For example, if the parents take the baby out away from home, after the infant is fed with milk, the parents usually still need to prepare an extra feeding bottle for filling with water or juice for the infant because to clean the original feeding bottle is inconvenient, especially outdoors. Further, because the multiple feeding bottles occupy too much space they are not convenient to carry.

To overcome the shortcomings, the present invention tends to provide a feeding bottle assembly so as to mitigate and obviate the aforementioned problems.

### SUMMARY OF THE INVENTION

An objective of the invention is to provide a feeding bottle assembly that is suitable to carry outdoors and has a compact space occupation, wherein the feeding bottle assembly is able to be assembled as a dual-bottle configuration to provide a warm-keeping function or to be separated into two singular bottles to provide different capacities.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a feeding bottle assembly in accordance with the present invention;

FIG. 2 is a cross-section view taken from line 2-2 in FIG. 1; FIG. 3 is a cross-section view of an internal bottle assembled with a cap in accordance with the present invention;

FIG. 4 a cross-section view of an external bottle assembled with the cap in accordance with the present invention;

FIG. 5 is an exploded perspective view showing a cylindrical block is installed into the cap by an auxiliary block in accordance with the present invention; FIG. 6 is a cross-section view showing the auxiliary block is assembled with the cylindrical block in accordance with the present invention; and

FIG. 7 is a cross-section view showing the auxiliary block is assembled with the cylindrical block in accordance with the present invention.

### DETAILED DESCRIPTION OF THE INVENTION

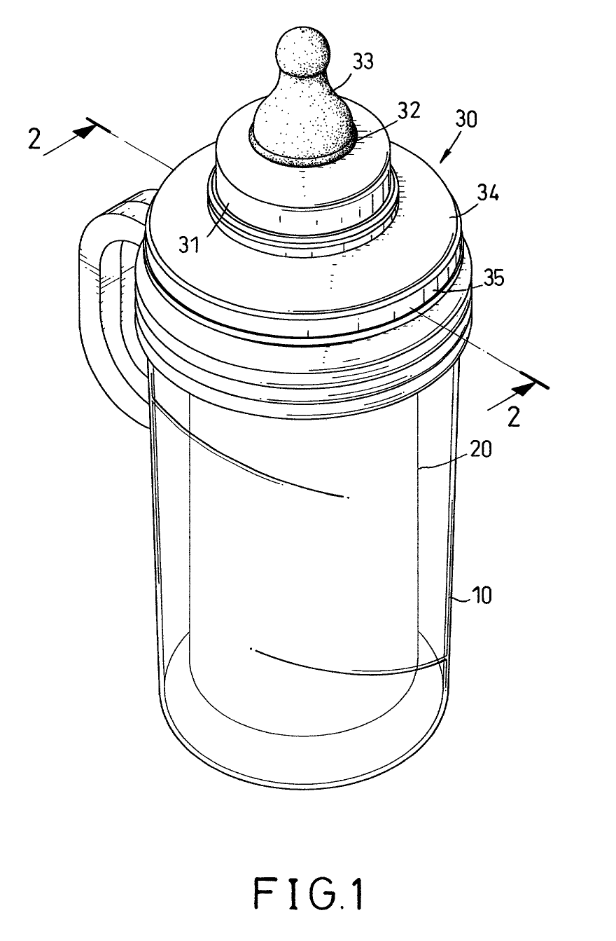

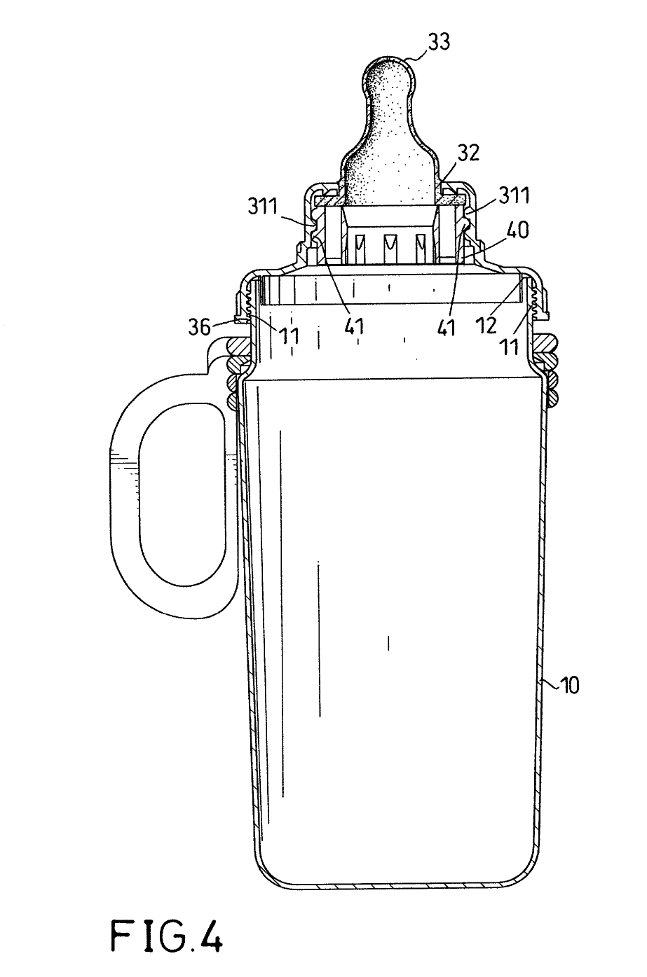

With reference to FIG. 1, a feeding bottle assembly in accordance with the present invention comprises an external bottle (10) with a first circular opening (12) (shown in FIG. 4), an internal bottle (20) with a second opening (22) (shown in FIG. 3), and a cap (30), wherein a first diameter of the first circular opening (12) is slightly bigger than that of the second opening (22), thus the internal bottle (20) is able to be received within the external bottle (10).

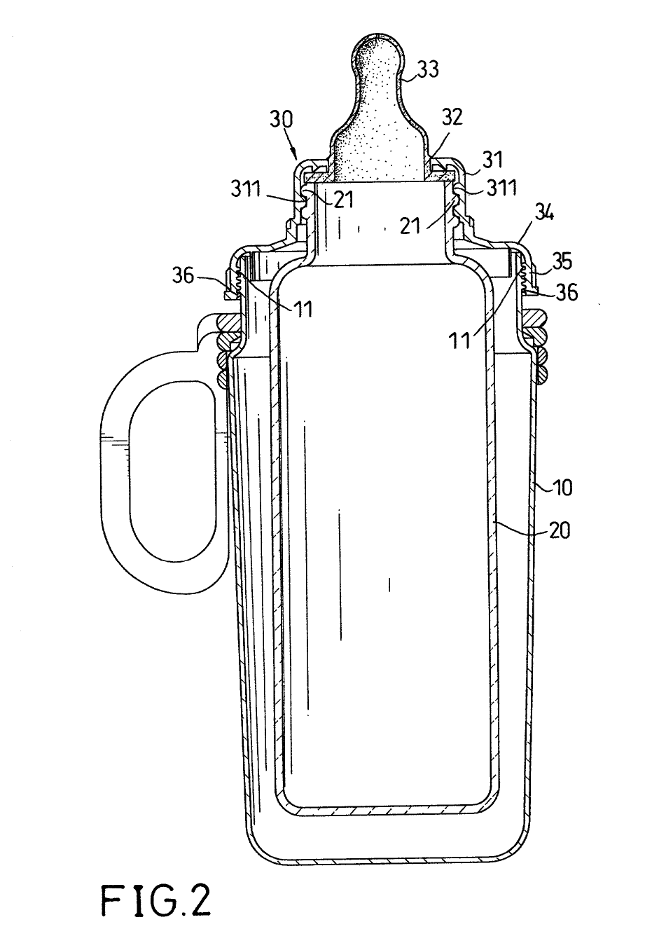

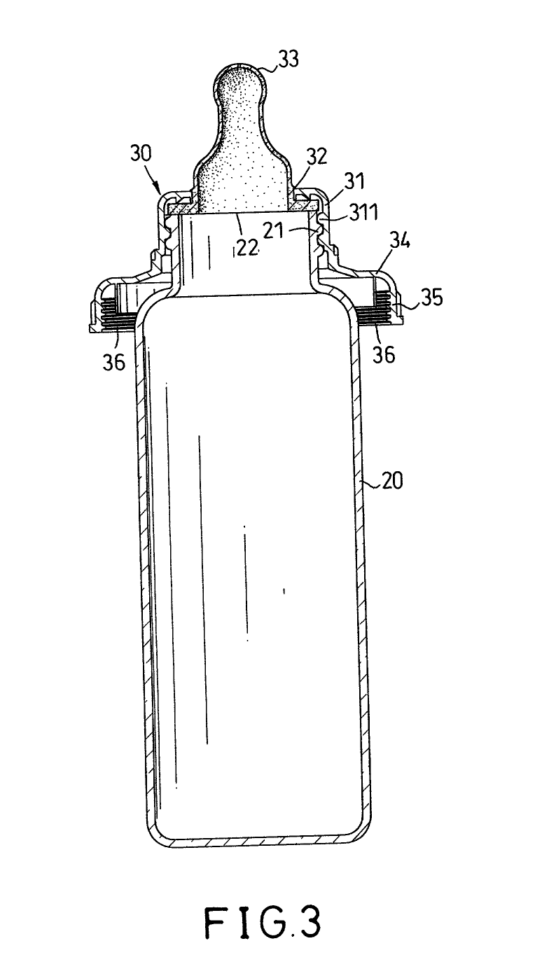

With reference to FIGS. 1 and 2, an upper portion of the internal bottle (20) is slightly tapered to form a neck portion (not numbered), wherein second threads (21) are formed around the outer periphery of the neck portion. The external bottle (10) also has a neck portion and first threads (11) integrally formed on the outer periphery of the neck portion.

The cap (30) has a hollow column portion (31) having a top plane and defining a top hole (32) at the top plane to receive a pacifier (33), wherein the pacifier (33) defines an outlet. A flat circular disc (34) is integrally formed at the periphery of a lower end of the column portion (31) and horizontally extends outward, wherein a brim portion (35) integrally extends downward from a circular flange of the disc (34).

An inner surface of the column portion (31) is formed with third threads (311) to correspond to the second threads (21) of the internal bottle (20), and an inner surface of the brim portion (35) of the cap (30) is also formed with fourth threads (36) to correspond to the first threads (11) of the external bottle (10).

The practical application of the present invention is variable, for example as shown in FIGS. 1 and 2, the cap (30) is firstly screwed with the internal bottle (20) via the second and third threads (21,311), and then the internal bottle (20) is placed inside the external bottle (10), wherein the second opening (22) communicates with the outlet of the pacifier (33). Thereafter, the cap (30) screws on the external bottle (10) via the first threads (11) and the fourth threads (36) on the brim portion (35). The external bottle (10) and the internal bottle (20) are assembled as a feeding bottle assembly with dual-bottle configuration.

The foregoing dual-bottle configuration assembly does not occupy much space, thus such an assembly is suitable to be carried out away from a home and is convenient to be stored. Further, either the external bottle (10) or the internal bottle (20) is able to be independently and selectively be used. For example, when the liquid food in the internal bottle (20) is finished off, the internal bottle (20) is taken out, and the external bottle (10) is used for filling with water or juice and without need for a cleaning procedure for the internal bottle (20).

Furthermore, since the internal bottle (20) is arranged inside the external bottle (20) and is not directly exposed to the environment air, the food within the internal bottle (20) would be kept in warm for a long time. If the external bottle (10) has hot water filled therein, the thermal insulating effect to the internal bottle would be greatly enhanced. On the contrary, if the external bottle (10) has cold water inside, when the internal bottle (20) is filled with hot liquid, such as hot milk, is placed in the external bottle (10), the cold water is able to quickly cool the hot liquid.

With reference to FIG. 3, the internal bottle (20) together with the cap (30) is another application type. The internal bottle (20) has a smaller capacity than the external bottle (10), such an application type is suitable for an infant who only requires a small quantity of food.

With reference to FIG. 4, if the external bottle (10) together with the cap (30) of the present invention are cooperated to form a single bottle, a cylindrical block (40) is necessary to be placed in the cap (30) to tightly press against the pacifier (33).

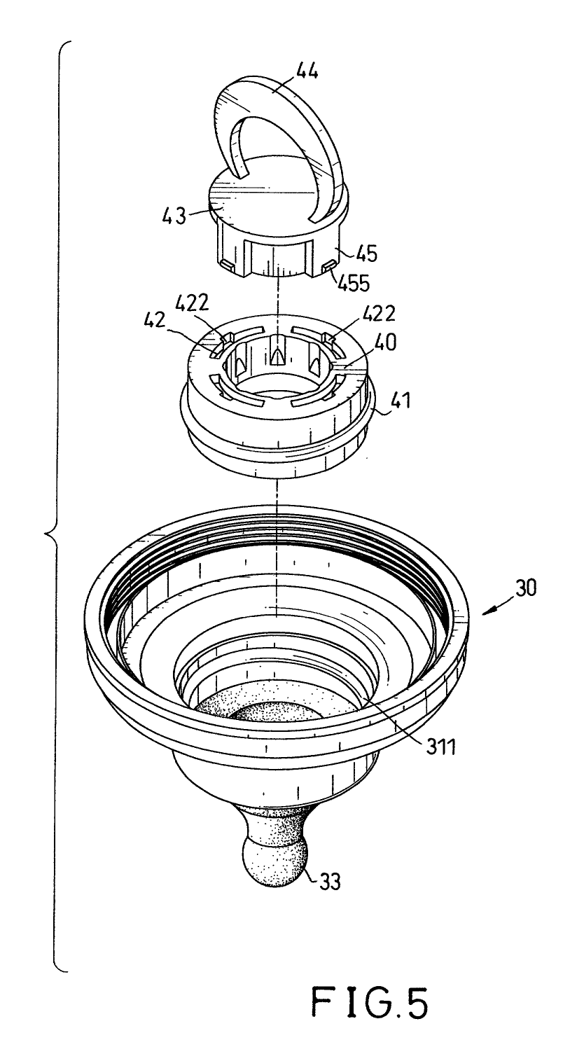

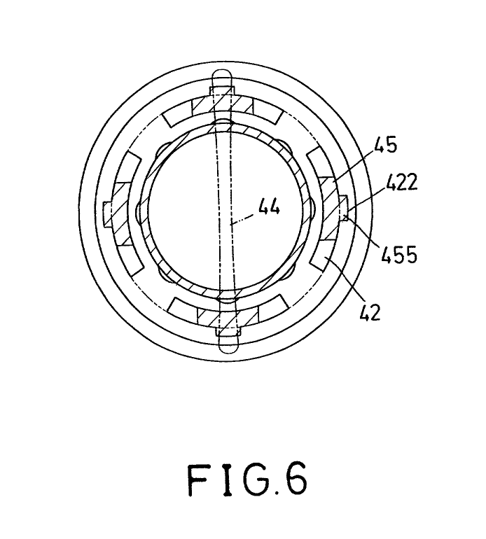

With reference to FIG. 5, the cylindrical block (40) defines a through hole in the center portion, wherein an outer diameter of the cylindrical block (40) corresponds to an inner diameter of the column portion (31) of the cap (30) so that the cylindrical block (40) is able to exactly be installed in the cap (30). The outer periphery of the cylindrical block (40) is formed with fifth threads (41) to correspond to the third threads (311) of the cap (30). The cylindrical block (40) further has multiple arcuate hollow notches (42) defining through a top surface of the block (40). Each notch (42) communicates with a positioning cut (422) defined at the top surface of the block (40).

Further, an auxiliary block (43) assists the cylindrical block (40) to assemble into the cap (30), wherein the auxiliary block (43) has a ring portion (44) formed on a top plane of the auxiliary block (43), and multiple legs (45) integrally extend downward from the top plane. Each of the multiple legs (45) has a protrusion (455) formed thereon.

To assemble the cylindrical block (40) with the cap (30), firstly the user holds the ring portion (44) and respectively plugs one of the multiple legs (45) into a corresponding one of the notches (42), wherein each protrusion (455) is also received in the corresponding positioning cut (422) (as shown in FIG. 6).

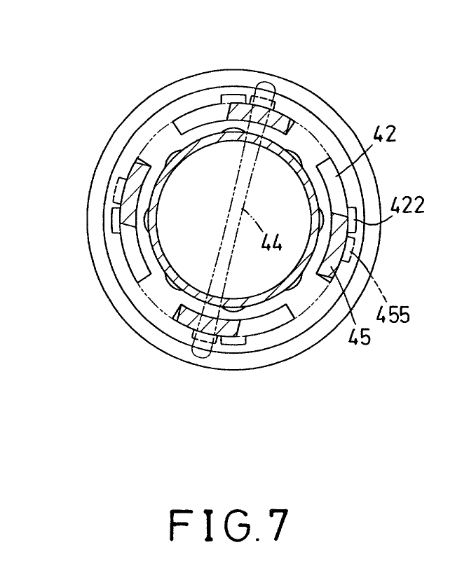

With reference to FIGS. 5 and 7, by slightly turning the auxiliary block (43), such as in a clockwise direction, to make each protrusion (455) securely engage in the notch (42), the auxiliary block (43) is firmly linked with the cylindrical block (40). The cylindrical block (40) is further placed in the cap (30) and then screwed to the cap (30) via the matched fifth threads (41) and the third threads (311). When the cylindrical block (40) is screwed to the cap (30), the auxiliary block (43) is turned in an opposite direction, such as in an counterclockwise direction, to remove from the cylindrical block (40), thus the cylindrical block (40) is securely arranged in the cap (30) and tightly presses against the pacifier (33). Thus the pacifier (33) is prevented from coming off from the cap (30) even when the flange of the opening (12) of the external bottle (10) is not pressed against the pacifier (33).

With reference to FIG. 4 again, after the cylindrical block (40) is installed in the cap (30) to place between the bottom of the pacifier (33) and the opening (12) of the external bottle (10), the cap (30) covers and screws the external bottle (10) via the first threads (11) and the fourth threads (36).

From the foregoing description, because the feeding bottle assembly of the present invention is able to configure as a dual-bottle type feeding bottle assembly, the assembly greatly saves the space that a single feeding bottle would occupy and provides an insulating or cooling function. Further, either the external bottle or the internal bottle is able to be independently used to provide different capacities for the infant.

The invention may be varied in many ways by a skilled person in the art. Such variations are not to be regarded as a departure from the spirit and scope of the invention, and all such modifications are intended to be included within the scope of the following claims.

What is claimed is:

1. A feeding bottle assembly comprising:
an external bottle (10) having a first opening (12) with a first diameter, wherein first threads (11) are formed around an outer periphery of an upper portion of the external bottle (10);
an internal bottle (20) having a second opening (22) with a second diameter, wherein second threads (21) are formed around an outer periphery of an upper portion of the internal bottle (20), and the second diameter is smaller than the first diameter so the internal bottle (20) is removeablely received inside the external bottle (10); and
a cap (30) for respectively or simultaneously enclosing the external bottle (10) and the internal bottle, wherein the cap (30) comprises:
a hollow column portion (31) having a top plane, wherein a hole (32) is defined at the top plane to receive a pacifier (33) and the hollow column portion (31) further has third threads (311) formed around an inner surface of the hollow column portion (31) to correspond to the second threads (21) of the internal bottle (20);
a circular disc (34) integrally formed around a periphery of a lower end of the hollow column portion (31) and horizontally extending outward; and
a brim portion (35) integrally extending downward from a circular flange of the circular disc (34), wherein the brim portion further has fourth threads (36) formed around an inner surface of the brim portion (35) to correspond to the first threads (11) of the external bottle (10).

2. A feeding bottle assembly comprising:
a first container (10) having a first opening (12) with a first diameter, wherein first threads (11) are formed around an outer periphery of an upper portion of the first container(10);
a cap (30) comprising:
a hollow column portion (31) having a top plane, wherein a hole (32) is defined at the top plane to receive a pacifier (33) and the hollow column portion (31) further has second threads (311) formed around an inner surface of the hollow column portion (31);
a circular disc (34) integrally formed around a periphery of a lower end of the hollow column portion (31) and horizontally extending outward; and
a brim portion (35) integrally extending downward from a circular flange of the circular disc (34), wherein the brim portion further has third threads (36) formed around an inner surface of the brim portion (35) to correspond to the first threads (11) of the first container (10); and
an abutting element having fourth threads formed on an outer surface of the butting element to correspond to the second threads (311) of the hollow column portion (31), so that the butting element is able to be screwed to the cap (30) and tightly press against the pacifier (33).

3. The feeding bottle assembly as claimed in claim 2, wherein the abutting element is a second container (20) and the second container (20) comprises:
a second opening (22) with a second diameter and communicating with an outlet of the pacifier (33), wherein the fourth threads (21) are formed around the outer surface of an upper portion of the second container (20), and the second diameter is smaller than the first diameter so the second container (20) is able to be received inside the first container(10).

4. The feeding bottle assembly as claimed in claim 2, wherein the abutting element is a cylindrical block (40) and the cylindrical block (40) has a through hole defines at a center portion of the cylindrical block (40) to allow food inside the first container (10) to flow into the pacifier (33).

5. The feeding bottle assembly as claimed in claim 4, wherein the cylindrical block (40) has a top surface defined through with multiple hollow notches (42), and each hollow notch (42) communicates with a positioning cut (422).

6. The feeding bottle assembly as claimed in claim 5 further having an auxiliary block (43) to assist the cylindrical block (40) to be arranged in the cap (30), wherein the auxiliary block (43) comprises:
a top plane;
a ring portion (44) formed upward on the top plane;
multiple legs (45) extending downward from the top plane and each leg (45) having a protrusion (455) formed on the leg (45), wherein each leg (45) corresponds to one of the multiple hollow notches (42) on the cylindrical block (40), and each protrusion (455) corresponds to the positioning cut (422), whereby the auxiliary block (43) is able to be plugged into the cylindrical block (40) so as to turn the cylindrical block (40) to screw to the cap (30).

7. A feeding bottle assembly comprising:
a first container (10) having a first opening (12) with a first diameter, wherein first threads (11) are formed around an outer periphery of an upper portion of the first container(10);
a cap (30) comprising:
a hollow column portion (31) having a top plane, wherein a hole (32) is defined at the top plane to receive a pacifier (33) and the hollow column portion (31) further has second threads (311) formed around an inner surface of the hollow column portion (31);
a circular disc (34) integrally formed around a periphery of a lower end of the hollow column portion (31) and horizontally extending outward; and
a brim portion (35) integrally extending downward from a circular flange of the circular disc (34), wherein the brim portion further has third threads (36) formed around an inner surface of the brim portion (35) to correspond to the first threads (11) of the first container (10); and
an abutting element having fourth threads formed on an outer surface of the butting element to correspond to the second threads (311) of the hollow column portion (31), so that the butting element is able to be screwed to the cap (30) and tightly press against the pacifier (33).

8. The feeding bottle assembly as claimed in claim 7, wherein the abutting element defines a through hole in a center portion of the abutting element to communicate with the outlet of the pacifier.

9. The feeding bottle assembly as claimed in claim 8, wherein a wall portion integrally extends downward from a circumference of a bottom plane of the abutting element to form a second container (20), wherein a space is defined inside the second container (20) to communicate with the through hole.

10. The feeding bottle assembly as claimed in claim 8, wherein the abutting element has a top surface defined with multiple hollow notches (42), and each hollow notch (42) communicates with a positioning cut (422).

11. The feeding bottle assembly as claimed in claim 10 further having an auxiliary block (43) to assist the abutting element to be arranged in the cap (30), wherein the auxiliary block (43) comprises:
a top plane;
a ring portion (44) formed upward on the top plane;
multiple legs (45) extending downward from the top plane and each leg (45) having a protrusion (455) formed on the leg (45), wherein each leg (45) corresponds to one of the multiple hollow notches (42) on the abutting element, and each protrusion (455) corresponds to the positioning cut (422), whereby the auxiliary block (43) is able to be plugged into the abutting element so as to turn the cylindrical abutting element to screw to the cap (30).
